(19) United States
(12) Patent Application Publication
(10) Pub. No.: US 2016/0140666 A1
(43) Pub. Date: May 19, 2016

(54) METHOD AND SYSTEM FOR INDEXING RETURN OF GOODS TO A MERCHANT

(71) Applicant: MASTERCARD INTERNATIONAL INCORPORATED, Purchase, NY (US)

(72) Inventors: Stephen Dantu, Armonk, NY (US); Divyam Mayawala, White Plains, NY (US); How Tam, Fort Lee, NJ (US)

(21) Appl. No.: 14/542,941

(22) Filed: Nov. 17, 2014

(51) Int. Cl. G06Q 40/00

(52) U.S. Cl. CPC G06Q 40/12

(57) ABSTRACT

A method and a system are provided for indexing returns of goods by a payment card holder to a merchant. The method includes retrieving a first set of information including payment card transaction information of a plurality of payment card holders; retrieving a second set of information including merchant information of a plurality of merchants; creating one or more benchmarks for a rate of return of goods by a plurality of payment card holders to a plurality of merchants; identifying a second rate of return of goods by a plurality of payment card holders to a selected merchant; and generating one or more indices based on the one or more benchmarks for the rate of return of goods by the plurality of payment card holders to the plurality of merchants and the second rate of return of goods by the plurality of payment card holders to the selected merchant.

### BACKGROUND OF THE DISCLOSURE

1. Field of the Disclosure

The present disclosure relates to a method and a system for indexing returns of goods by a payment card holder to a merchant. In particular, one or more indices are generated based on one or more benchmarks for rate of return of goods by a plurality of payment card holders to a plurality of merchants and rate of return of goods by the plurality of payment card holders to a selected merchant. Based on the one or more indices, the rate of return of goods by the plurality of payment card holders to the selected merchant is then assessed.

2. Description of the Related Art

The first credit payment systems were two party systems in which a merchant sold goods to a customer without requiring full or any initial payment, and the customer paid for the goods at a later date, or made periodic payments over a predetermined period of time. These two party system methods of payment are of limited scope, and are not flexible in that they involve only one merchant, and the customer must make individual arrangements with each and every merchant, and for each and every transaction.

In a three party system, a single card issuer contracts with customers and issues credit cards to them. The issuer also contracts with merchants, who agree to make sales to customers having a credit card from the issuer. When a card is presented at a merchant's establishment, it is generally the issuer who approves the transaction and pays the merchant. However, this system, a so-called closed system, has occasionally been modified so that another party approves the transaction and interacts with the merchant.

MasterCard®, the assignee of the present application, operates in what is known as a “four-party” payment card system, described in more detail below. The four key participants in a four-party system are: (i) the consumer and business cardholders that use the cards; (ii) the merchants that accept the cards; (iii) the financial institutions that issue the cards (referred to as the card issuer); and (iv) the financial institutions that sign up merchants to accept the cards (referred to as the acquirer).

In general, the transaction system and associated methods described below with reference to FIG. 1 work well. However, there are situations in which a return of a good and refund of a purchase price must be provided to a customer. A sales return of a good usually occurs for one of the following reasons: excess quantity shipped; excess quantity ordered; defective goods; goods shipped too late; product specifications are incorrect; wrong items shipped; customer did not like the good; customer fraudulent activity; and the like.

Return of goods by customers is one of the largest forms of losses for a merchant. According to industry estimates, consumers return about $264 billion worth of merchandise, or almost 9 percent of total sales, each year. Merchants are interested not only in keeping their returns low or at the least, on par with the industry, but also in ensuring they have repeat business from consumers that do makes returns.

There is a need for a system that can provide more effective information, including benchmark information of other merchants, to a merchant to enable the merchant to compare its return losses with other merchants. A more holistic view of a merchant's return losses is needed for effective business strategy planning by a merchant. In particular, there is a need for a system that can provide to a merchant timely comparative benchmarked information of merchant return losses, so that the merchant can compare its return losses with other merchants in the same industry, geographical location, and similar sales volumes. Further, there is a need for a system that can analyze a merchant's return losses and other circumstances that are specifically tailored to the merchant's need or desire, and communicate that information to the merchant.

### SUMMARY OF THE DISCLOSURE

The present disclosure provides a method and a system for indexing returns of goods by a payment card holder to a merchant. In particular, one or more benchmarks are created for a rate of return of goods by a plurality of payment card holders to a plurality of merchants based on payment card transaction information and merchant information. One or more indices are generated based on the one or more benchmarks for rate of return of goods by the plurality of payment card holders to the plurality of merchants and the rate of return of goods by the plurality of payment card holders to a selected merchant. The rate of return of goods by the plurality of payment card holders to the selected merchant is then assessed based on the one or more indices.

The present disclosure provides a method that involves retrieving from one or more databases a first set of information comprising payment card transaction information of a plurality of payment card holders; and retrieving from one or more databases a second set of information comprising merchant information of a plurality of merchants. The method further involves creating one or more benchmarks for a rate of return of goods by a plurality of payment card holders to a plurality of merchants based on the first set of information and the second set of information; identifying a rate of return of goods by a plurality of payment card holders to a selected merchant based on the first set of information and the second set of information; generating one or more indices based on the one or more benchmarks for rate of return of goods by the plurality of payment card holders to the plurality of merchants and the rate of return of goods by the plurality of payment card holders to the selected merchant; and assessing the rate of return of goods by the plurality of payment card holders to the selected merchant based on the one or more indices. In particular, the method involves creating one or more benchmarks for a rate of return of goods by a plurality of payment card holders to a plurality of merchants across one or more merchant categories, merchant sales volumes, and merchant geographies.

The present disclosure also provides a system that includes one or more databases configured to store a first set of information comprising payment card transaction information of a plurality of payment card holders; and one or more databases configured to store a second set of information comprising merchant information of a plurality of merchants. The system also includes a processor configured to: create one or more benchmarks for a rate of return of goods by a plurality of payment card holders to a plurality of merchants based on the first set of information and the second set of information; identify a rate of return of goods by a plurality of payment card holders to a selected merchant based on the first set of information and the second set of information; generate one or more indices based on the one or more benchmarks for rate of return of goods by the plurality of payment card holders to the plurality of merchants and the rate of return of goods by the plurality of payment card holders to the selected merchant; and assess the rate of return of goods by the plurality of payment card holders to the selected merchant based on the one or more indices. In particular, the processor is configured to create one or more benchmarks for a rate of return of goods by a plurality of payment card holders to a plurality of merchants across one or more merchant categories, merchant sales volumes, and merchant geographies.

The present disclosure further provides a method for generating one or more predictive behavioral models. The method involves retrieving from one or more databases a first set of information comprising payment card transaction information of a plurality of payment card holders; and retrieving from one or more databases a second set of information comprising merchant information of a plurality of merchants. The method further involves creating one or more benchmarks for a rate of return of goods by a plurality of payment card holders to a plurality of merchants based on the first set of information and the second set of information; identifying a rate of return of goods by a plurality of payment card holders to a selected merchant based on the first set of information and the second set of information; generating one or more indices based on the one or more benchmarks for rate of return of goods by the plurality of payment card holders to the plurality of merchants and the rate of return of goods by the plurality of payment card holders to the selected merchant; extracting information related to an intent of the plurality of payment card holders based on the one or more indices; and generating one or more predictive behavioral models based on the one or more indices and the intent of the plurality of payment card holders. The plurality of payment card holders have a propensity to carry out certain activities based on the one or more predictive behavioral models.

In particular, the method involves assessing the propensity of the plurality of payment card holders to (i) return goods to a merchant including frequency and time of return of goods to a merchant; (ii) shop at a merchant after the return of goods to the merchant including frequency and time of shopping at the merchant; and (iii) purchase at a merchant after the return of goods to the merchant including frequency and time of purchasing at the merchant, based on the one or more predictive behavioral models.

### BRIEF DESCRIPTION OF THE DRAWINGS

FIG. 1 is a diagram of a four party payment card system.

FIG. 2 illustrates a data warehouse shown in FIG. 1 that is a central repository of data that is created by storing certain transaction data from transactions occurring in four party payment card system of FIG. 1.

FIG. 3 shows illustrative information types used in the systems and the methods of the present disclosure.

FIG. 4 shows illustrative merchants in selected industry categories in accordance with exemplary embodiments of the present disclosure.

FIG. 5 illustrates an exemplary dataset for the storing, reviewing, and/or analyzing of information used in the systems and the methods of the present disclosure.

FIG. 6 is a block diagram illustrating a method for conveying suggestions or recommendations to a merchant based on indices in accordance with exemplary embodiments of the present disclosure.

FIG. 7 is a flow chart illustrating a method for creating benchmarks across merchant industries, sales volumes and geographies, identifying return of goods to a selected merchant, and creating indices based on the benchmarks and the return of good to the selected merchant, in accordance with exemplary embodiments of the present disclosure.

FIG. 8 is a table illustrating benchmark data across hardware merchant industry, sales volumes and geographies, in accordance with exemplary embodiments of the present disclosure.

FIG. 9 illustrates an exemplary calculation of indices for a merchant, in accordance with exemplary embodiments of the present disclosure.

FIG. 10 illustrates an exemplary merchant report that includes merchant information, indices and other calculated information, in accordance with exemplary embodiments of the present disclosure.

FIG. 11 is a block diagram illustrating a method for generating one or more predictive behavioral models in accordance with exemplary embodiments of the present disclosure.

A component or a feature that is common to more than one drawing is indicated with the same reference number in each drawing.

### DESCRIPTION OF THE PREFERRED EMBODIMENTS

Embodiments of the present disclosure are described more fully hereinafter with reference to the accompanying drawings, in which some, but not all, embodiments of the present disclosure are shown. Indeed, the present disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for a particular product, charity, not-for-profit organization, labor union, local government, government agency, or political party. It should be understood that the methods and systems of this disclosure can be practiced by a single entity or by multiple entities. Although different entities can carry out different steps or portions of the methods and systems of this disclosure, all of the steps and portions included in the methods and systems of this disclosure can be carried out by a single entity.

As used herein, the term “payment card” is intended to include not only physical cards, such as credit and debit cards, but also any type of electronic payment account instrument that can be used to complete a non-cash financial transaction, including, without limitation, virtual account numbers, electronic wallets, cloud-based payments, and the like.

As used herein, the one or more databases configured to store the first set of information or from which the first set of information is retrieved, and the one or more databases configured to store the second set of information or from which the second set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage device, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to retrieve from one or more databases a first set of information comprising payment card transaction information (e.g., payment card holder information, transaction amount, transaction refund information, and the like) of a plurality of payment card holders, and retrieving from one or more databases a second set of information comprising merchant information (e.g., categories of merchants, and the like). One or more benchmarks for a rate of return of goods by a plurality of payment card holders to a plurality of merchants are created based on the first set of information and the second set of information. A rate of return of goods by a plurality of payment card holders to a selected merchant is identified based on the first set of information and the second set of information. One or more indices are generated based on the one or more benchmarks for rate of return of goods by the plurality of payment card holders to the plurality of merchants and the rate of return of goods by the plurality of payment card holders to the selected merchant. The rate of return of goods by the plurality of payment card holders to the selected merchant based on the one or more indices is then assessed.

Among many potential uses, the systems and methods described herein can be used to create several metrics for use by a merchant. Illustrative merchant metrics derived from payment card transaction information and merchant information include: (1) consumer return of goods index; (2) percent of consumers that return goods to the merchant; (3) percent of consumers that shopped at the merchant after the return of goods to the merchant; (4) percent of consumers that purchased goods at the merchant after the return of goods to the merchant; (5) average duration (in days, for example) of consumers next purchase of goods at the merchant after the return of goods to the merchant; and (6) monthly/quarterly time series reports of consumer return of goods index and other indices. Other metrics and uses are possible.

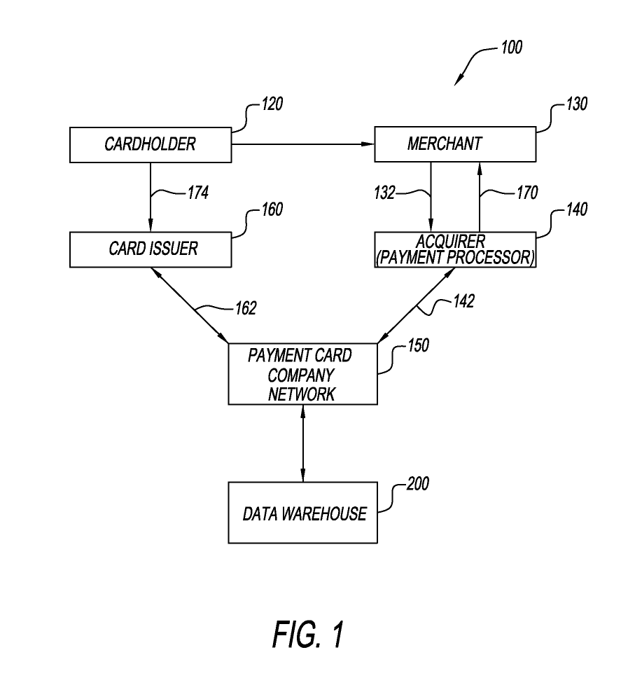

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes a financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, if the transaction is approved, the card holder completes the purchase and receives a receipt.

The account of the merchant 130 is credited, via 170, by the acquirer 140. The card issuer 160 pays the acquirer 140 through the payment card company network 150. Eventually, the card holder 120 pays, via 174, the card issuer 160.

Data warehouse 200 is a database used by payment card company network 150 for reporting and data analysis. According to one embodiment, data warehouse 200 is a central repository of data that is created by storing certain transaction data from transactions occurring within four party payment card system 100. According to another embodiment, data warehouse 200 stores, for example, the date, time, amount, location, merchant code, and merchant category for every transaction occurring within payment card network 150.

In yet another embodiment, data warehouse 200 stores, reviews, and/or analyzes information used in: (i) creating one or more benchmarks for a rate of return of goods by a plurality of payment card holders to a plurality of merchants based on the first set of information and the second set of information; (ii) identifying a rate of return of goods by a plurality of payment card holders to a selected merchant based on the first set of information and the second set of information; (iii) generating one or more indices based on the one or more benchmarks for rate of return of goods by the plurality of payment card holders to the plurality of merchants and the rate of return of goods by the plurality of payment card holders to the selected merchant; (iv) assessing the rate of return of goods by the plurality of payment card holders to the selected merchant based on the one or more indices; and (v) generating one or more predictive behavioral models based on the one or more indices and intent of the plurality of payment card holders.

In still another embodiment, data warehouse 200 stores, reviews, and/or analyzes information used in creating one or more datasets to store information relating to: (i) one or more benchmarks for a rate of return of goods by a plurality of payment card holders to a plurality of merchants based on the first set of information and the second set of information; (ii) rate of return of goods by a plurality of payment card holders to a selected merchant based on the first set of information and the second set of information; (iii) one or more indices based on the one or more benchmarks for rate of return of goods by the plurality of payment card holders to the plurality of merchants and the rate of return of goods by the plurality of payment card holders to the selected merchant; (iv) rate of return of goods by the plurality of payment card holders to the selected merchant based on the one or more indices; and (v) one or more predictive behavioral models based on the one or more indices and intent of the plurality of payment card holders.

In another embodiment, data warehouse 200 stores, reviews, and/or analyzes information used in developing logic for: (i) creating one or more benchmarks for a rate of return of goods by a plurality of payment card holders to a plurality of merchants based on the first set of information and the second set of information; (ii) identifying a rate of return of goods by a plurality of payment card holders to a selected merchant based on the first set of information and the second set of information; (iii) generating one or more indices based on the one or more benchmarks for rate of return of goods by the plurality of payment card holders to the plurality of merchants and the rate of return of goods by the plurality of payment card holders to the selected merchant; (iv) assessing the rate of return of goods by the plurality of payment card holders to the selected merchant based on the one or more indices; and (v) generating one or more predictive behavioral models based on the one or more indices and intent of the plurality of payment card holders.

In still another embodiment, data warehouse 200 stores, reviews, and/or analyzes information used in quantifying the strength of the: (i) one or more benchmarks for a rate of return of goods by a plurality of payment card holders to a plurality of merchants based on the first set of information and the second set of information; (ii) rate of return of goods by a plurality of payment card holders to a selected merchant based on the first set of information and the second set of information; (iii) one or more indices based on the one or more benchmarks for rate of return of goods by the plurality of payment card holders to the plurality of merchants and the rate of return of goods by the plurality of payment card holders to the selected merchant; (iv) rate of return of goods by the plurality of payment card holders to the selected merchant based on the one or more indices; and (v) one or more predictive behavioral models based on the one or more indices and intent of the plurality of payment card holders.

In still another embodiment, data warehouse 200 stores, reviews, and/or analyzes information used in targeting information including at least one or more suggestions or recommendations for a merchant, based on the one or more indices.

In another embodiment, data warehouse 200 aggregates merchant information across one or more merchant categories, merchant geographical locations, and/or merchant sales volumes. In yet another embodiment, data warehouse 200 aggregates the information by payment card holder, merchant, category and/or location. In still another embodiment, data warehouse 200 integrates data from one or more disparate sources. Data warehouse 200 stores current as well as historical data and is used for creating reports, performing analyses on the network, merchant analyses, and performing predictive analyses.

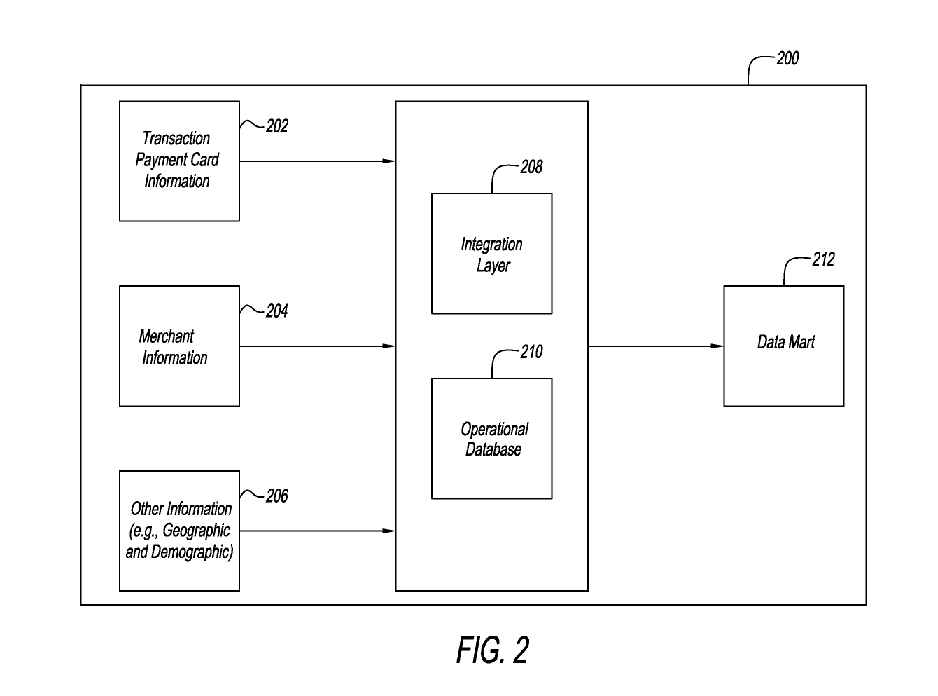

Referring to FIG. 2, an exemplary data warehouse 200 (the same data warehouse 200 in FIG. 1) for reporting and data analysis, including the storing, reviewing, and/or analyzing of information, for the various purposes described above is shown. The data warehouse 200 can have a plurality of entries (e.g., entries 202, 204 and 206).

The transaction payment card information 202 can include, for example, payment card transaction information, payment card holder information, and purchasing and payment activities attributable to payment card holders, that can be aggregated by payment card holder, category and/or location in the data warehouse 200. The transaction payment card information 202 can also include, for example, a transaction identifier, geolocation of payment card transaction, geolocation date on which payment card transaction occurred, geolocation time on which payment card transaction occurred, and the like.

The merchant information 204 can include, for example, categories of merchants, and the like. The merchant information 204 can also include, for example, a merchant identifier, geolocation of merchant, and the like.

The other information 206 includes, for example, geographic data, firmographic data, and demographic data. The other information 206 can include other suitable information that can be useful in creating one or more benchmarks for a rate of return of goods by a plurality of payment card holders to a plurality of merchants based on the first set of information and the second set of information; identifying a rate of return of goods by a plurality of payment card holders to a selected merchant based on the first set of information and the second set of information; generating one or more indices based on the one or more benchmarks for rate of return of goods by the plurality of payment card holders to the plurality of merchants and the rate of return of goods by the plurality of payment card holders to the selected merchant; assessing the rate of return of goods by the plurality of payment card holders to the selected merchant based on the one or more indices; and generating one or more predictive behavioral models based on the one or more indices and intent of the plurality of payment card holders.

The typical data warehouse uses staging, data integration, and access layers to house its key functions. The staging layer or staging database stores raw data extracted from each of the disparate source data systems. At 208, the integration layer integrates the disparate data sets by transforming the data from the staging layer often storing this transformed data in an operational data store database 210. The integration involves forming, coordinating and/or blending the disparate data sets into a functioning or unified whole. For example, the payment card transaction information 202 can be aggregated by merchant, category and/or location at integration layer 208. The integrated data (e.g., aggregated data) can then be stored in the operational data store database 210. The operational data store database 210 serves as a repository for the integrated data for general areas of interest that can be accessed for the various purposes described above. As described herein, the integrated data for general areas of interest stored in operational data store database 210 can be moved to data mart 212 and accessed where the focus is on more specific areas of interest.

The integrated data is moved to yet another database, often called the data warehouse database or data mart 212, where the data is arranged into hierarchical groups often called dimensions and into facts and aggregate facts. The access layer helps users retrieve data.

A data warehouse constructed from an integrated data source system does not require staging databases or operational data store databases. The integrated data source systems can include a part of a distributed operational data store layer. Data federation methods or data virtualization methods can be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 212 is a small data warehouse focused on a specific area of interest. For example, the data mart 212 can be focused on one or more of reporting and data analysis, including the storing, reviewing, and/or analyzing of information, for any of the various purposes described above. Data warehouses can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information using any of a variety of known mathematical techniques. These formulas in turn can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

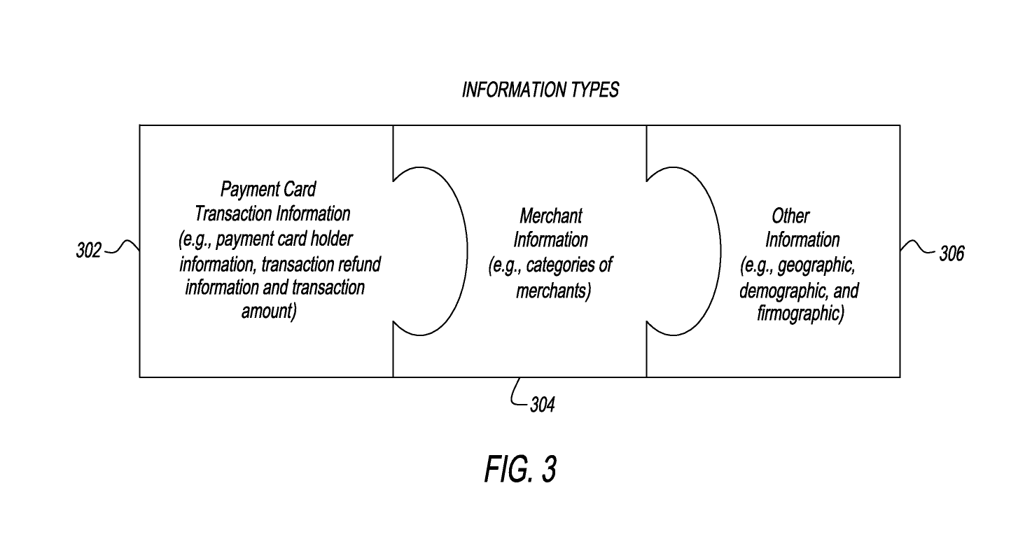

In accordance with the method of this disclosure, information that is stored in one or more databases can be retrieved (e.g., by a processor). FIG. 3 shows illustrative information types used in the systems and methods of this disclosure.

The information can contain, for example, a first set of information 302 that can be retrieved from one or more databases owned or controlled by an entity, for example, a payment card company (part of the payment card company network 150 in FIG. 1). The transaction payment card information 302 can contain, for example, payment card transaction information, payment card holder information (e.g., payment card holder account identifier (likely anonymized), payment card holder geography (potentially modeled), payment card holder type (consumer/business), payment card holder demographics, and the like), and purchasing and payment activities attributable to payment card holders, that can be aggregated by payment card holder, category and/or location, transaction date and time, and transaction amount. The transaction payment card information 302 can also include, for example, a transaction identifier, geolocation of payment card transaction, geolocation date on which payment card transaction occurred, geolocation time on which payment card transaction occurred, and the like. Information for inclusion in the first set of information can be obtained, for example, from payment card companies known as MasterCard®, Visa®, American Express®, and the like (part of the payment card company network 150 in FIG. 1).

The merchant information 304 can include, for example, categories of merchants, merchant name, merchant geography, merchant line of business, and the like. The merchant information 304 can also include, for example, a merchant identifier, geolocation of merchant, and the like.

One or more databases are used for storing information of one or more merchants, and merchants belonging to a particular category, e.g., industry category. Illustrative merchant categories are described herein. The merchant categorization is useful for creating one or more benchmarks for a rate of return of goods by a plurality of payment card holders to a plurality of merchants based on the first set of information and the second set of information; generating one or more indices based on the one or more benchmarks for rate of return of goods by the plurality of payment card holders to the plurality of merchants and the rate of return of goods by the plurality of payment card holders to the selected merchant; and generating one or more predictive behavioral models based on the one or more indices and intent of the plurality of payment card holders.

In an embodiment, a merchant category can include a segment of a particular industry. In some embodiments, the merchant category can be defined using merchant category codes according to predefined industries, which can be aligned using standard industrial classification codes, or using the industry categorization described herein.

Merchant categorization indicates the category or categories assigned to each merchant name. As described herein, merchant category information is used primarily for purposes described above, although other uses are possible. According to one embodiment, each merchant name is associated with only one merchant category. In alternate embodiments, however, merchants are associated with a plurality of categories as apply to their particular businesses. Generally, merchants are categorized according to conventional industry codes as defined by a selected external source (e.g., a merchant category code (MCC), Hoovers™, the North American Industry Classification System (NAICS), and the like). However, in one embodiment, merchant categories are assigned based on system operator preferences, or some other similar categorization process.

An illustrative merchant categorization including industry codes is set forth below.

| INDUSTRY | INDUSTRY NAME |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable Services |
| CUE | College, University Education |
| CUF | Clothing, Uniform, Costume Rental |
| DAS | Dating Services |
| DCS | Death Care Services |
| DIS | Discount Department Stores |
| DLS | Drycleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |

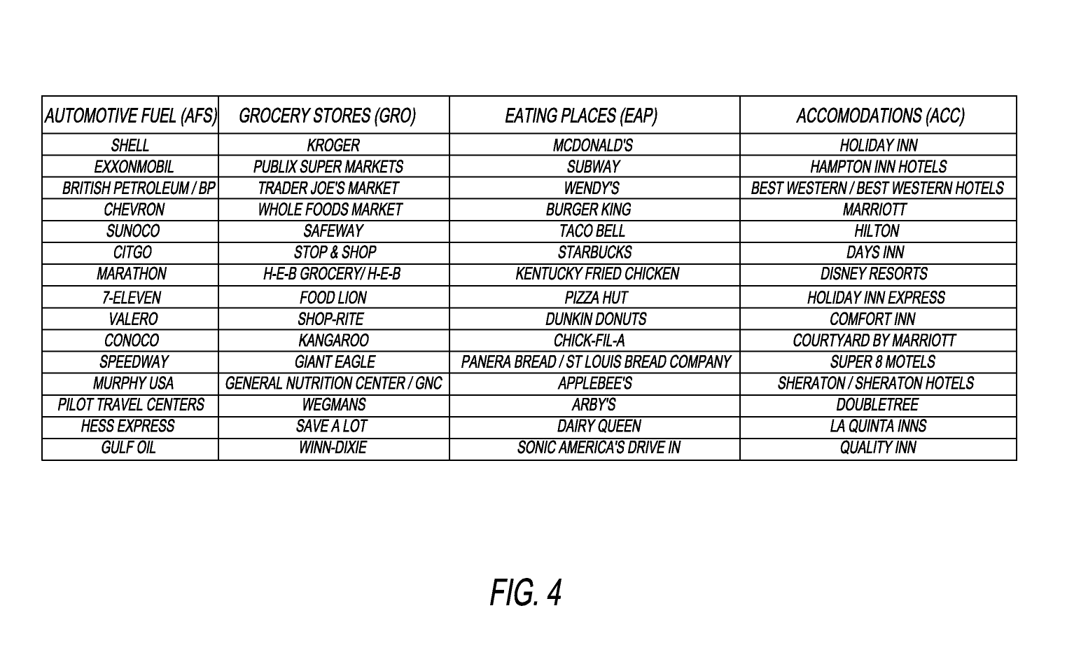

Illustrative merchants and industry categorization are shown in FIG. 4. The illustrative industry categories include AFS Automotive Fuel, GRO Grocery Stores, EAP Eating Places, and ACC Accommodations. Illustrative merchants associated with the industry categories are listed in FIG. 4. In accordance with this disclosure, merchant categorization is important for indexing returns of goods by a payment card holder to a merchant. Proper merchant categorization is important to obtain indexing results that are truly reflective of the particular merchant and industry, in particular, to determine how the returns of goods by a payment card holder to a merchant is trending for one merchant in comparison to another merchant in the same industry category.

Also, the information can optionally include, for example, a third set of information including other information 306. Illustrative third set information can include, for example, geographic data, firmographic data, demographic data, and the like. In particular, the third set of information can include, for example, geographic data, geographic areas (e.g., ZIP codes, metropolitan areas (metropolitan statistical area (MSA), designated market area (DMA), and the like), event venues, and the like), calendar information (e.g., open seasons such as beach seasons, ski seasons, and the like, retail calendar, seasonal/holiday information such as observances of shifting holidays such as Easter), weather (e.g., snowfall, rain, temperature, and the like), and the like. The third set of information affords leveraged data sources that can supplement information in the first set of information and the second set of information.

The other information 306 can further include firmographics data, for example, line of operations for a business, information related to employees, revenues and industries, and the like. In particular, the firmographics data relates to information on merchants that is typically used in credit decisions, business-to-business marketing and supply chain management.

Illustrative information in the firmographics data source includes, for example, information concerning merchant background, merchant history, merchant special events, merchant operation, merchant payments, merchant payment trends, merchant financial statement, merchant public filings, and the like merchant information.

Merchant background information can include, for example, ownership, history and principals of the merchant, and the operations and location of the merchant.

Merchant history information can include, for example, incorporation details, par value of shares and ownership information, background information on management, such as educational and career history and company principals, related companies including identification of affiliates including, but not limited to, parent, subsidiaries and/or branches worldwide. The merchant history information can also include corporate registration details to verify the existence of a registered organization, confirm legal information such as a merchant's organizational structure, date and state of incorporation, and research possible fraud by reviewing names of principals and business standing in a state.

Merchant special event information can include, for example, any developments that can impact a potential relationship with a company, such as bankruptcy filings, changes in ownership, acquisitions and other events. Other special event information can include announcements on the release of earnings reports. Special events can help explain unusual company trends, for example, a change in ownership could have an impact on manner of payment, or decreased production may reflect an unexpected interruption in factory operations (i.e., labor strike or fire).

Merchant operational information can include, for example, the identity of the parent company, the number of accounts and geographic scope of the business, typical selling terms, and whether the merchant owns or leases its facilities. The names and locations of branch operations and subsidiaries can also be identified.

Merchant payment information can include, for example, a listing of recent payments made by a company. An unusually large number of transactions during a single month or time period can indicate a seasonal purchasing pattern. The information can show payments received prior to date of invoice, payments received within trade discount period, payments received within terms granted, and payments beyond vendor's terms.

Merchant payment trend information can include, for example, information that spots trends in a merchant's business by analyzing how it pays its bills.

Merchant financial statement information can include, for example, a formal record of the financial activities and a snapshot of a merchant's financial health. Financial statements typically include four basic financial statements, accompanied by a management discussion and analysis. The Balance Sheet reports on a company's assets, liabilities, and ownership equity at a given point in time. The Income Statement reports on a company's income, expenses, and profits over a period of time. Profit & Loss accounts provide information on the operation of the enterprise. These accounts include sale and the various expenses incurred during the processing state. The Statement of Retained Earnings explains the changes in a company's retained earnings over the reporting period. The Statement of Cash Flows reports on a company's cash flow activities, particularly its operating, investing and financing activities.

Merchant public filing information can include, for example, bankruptcy filings, suits, liens, and judgment information obtained from Federal and State court houses for a company.

Demographic information can also be used to supplement or leverage the first set of information and the second set of information. Illustrative demographic information includes, for example, age, income, presence of children, education, and the like.

With regard to the sets of information, filters can be employed to select particular portions of the information. For example, time range filters can be used that can vary based on need or availability.

In an embodiment, all information stored in each of the one or more databases can be retrieved. In another embodiment, only a single entry in each database can be retrieved. The retrieval of information can be performed a single time, or can be performed multiple times. In an exemplary embodiment, only information pertaining to a specific benchmark or index is retrieved from each of the databases.

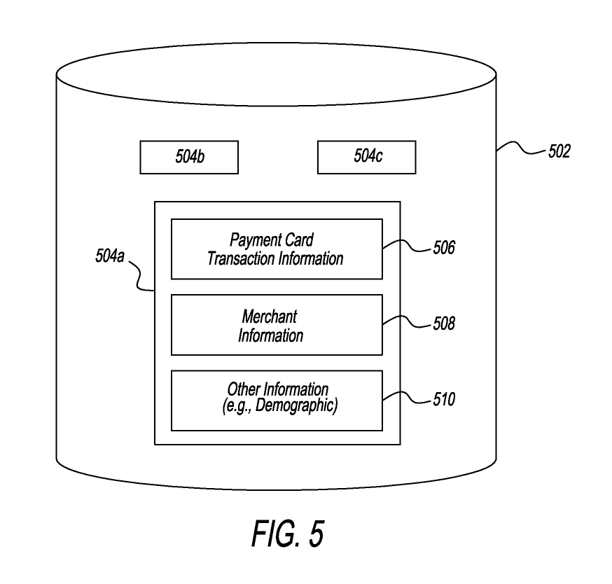

Referring to FIG. 5, an exemplary dataset 502 stores, reviews, and/or analyzes of information used in the systems and methods of this disclosure. The dataset 502 can include a plurality of entries (e.g., entries 504a, 504b, and 504c).

The payment card transaction information 506 includes payment card transactions and actual spending by, and refunds made to, payment card holders. More specifically, payment card transaction information 506 can include, for example, payment card transaction information, transaction date and time, transaction amount, payment card holder information (e.g., payment card holder account identifier (likely anonymized), payment card holder geography (potentially modeled), payment card holder type (consumer/business), payment card holder demographics, and the like), and purchasing and payment activities attributable to payment card holders, that can be aggregated by payment card holder, category and/or location, transaction date and time, and transaction amount. The transaction payment card information 506 can also include, for example, a transaction identifier, geolocation of payment card transaction, geolocation date on which payment card transaction occurred, geolocation time on which payment card transaction occurred, and the like. Information for inclusion in the first set of information can be obtained, for example, from payment card companies known as MasterCard®, Visa®, American Express®, and the like (part of the payment card company network 150 in FIG. 1).

The merchant information 508 can include, for example, categories of merchants, merchant name, merchant geography, merchant line of business, and the like. The merchant information 508 can also contain, for example, a merchant identifier, geolocation of merchant, and the like.

The other information 510 includes, for example, geographic data, firmographic data, demographic data, and other suitable information that can be useful in conducting the systems and methods of this disclosure.

Algorithms can be employed to determine formulaic descriptions of the integration of the payment card transaction information 506, merchant information 508 and optionally the other information 510 using any of a variety of known mathematical techniques. These formulas, in turn, can be used to derive or generate one or more analyses and updates using any of a variety of available trend analysis algorithms. For example, these formulas can be used to create one or more benchmarks for a rate of return of goods by a plurality of payment card holders to a plurality of merchants based on the first set of information and the second set of information; identify a rate of return of goods by a plurality of payment card holders to a selected merchant based on the first set of information and the second set of information; generate one or more indices based on the one or more benchmarks for rate of return of goods by the plurality of payment card holders to the plurality of merchants and the rate of return of goods by the plurality of payment card holders to the selected merchant; assess the rate of return of goods by the plurality of payment card holders to the selected merchant based on the one or more indices; and generate one or more predictive behavioral models based on the one or more indices and intent of the plurality of payment card holders.

In an embodiment, logic is developed for creating one or more benchmarks for a rate of return of goods by a plurality of payment card holders to a plurality of merchants based on the first set of information and the second set of information; identifying a rate of return of goods by a plurality of payment card holders to a selected merchant based on the first set of information and the second set of information; generating one or more indices based on the one or more benchmarks for rate of return of goods by the plurality of payment card holders to the plurality of merchants and the rate of return of goods by the plurality of payment card holders to the selected merchant; assessing the rate of return of goods by the plurality of payment card holders to the selected merchant based on the one or more indices; and generating one or more predictive behavioral models based on the one or more indices and intent of the plurality of payment card holders. The logic is applied to a universe of payment card holders to identify return of goods patterns and purchasing and payment activities of the universe of payment card holders.

In accordance with the method of this disclosure, information that is stored in one or more databases can be retrieved (e.g., by a processor). The information can include, for example, billing activities attributable to the financial transaction processing entity (e.g., a payment card company) and purchasing and payment activities, including date and time, attributable to payment card holders, merchant information, demographic (e.g., age and gender), geographic (e.g., zip code and state or country of residence), and the like. Other illustrative information can include, for example, demographic (e.g., age and gender), geographic (e.g., zip code and state or country of residence), and the like.

In an embodiment, all information stored in each database can be retrieved. In another embodiment, only a single entry in each of the one or more databases can be retrieved. The retrieval of information can be performed a single time, or can be performed multiple times. In an exemplary embodiment, only information pertaining to a specific predictive behavioral model is retrieved from each of the databases.

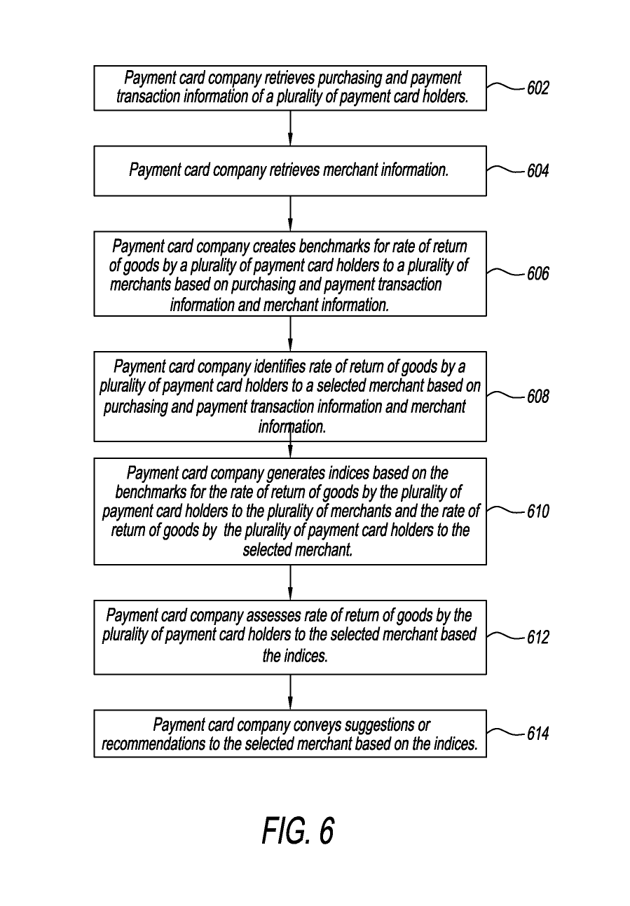

FIG. 6 illustrates an exemplary method for an entity (e.g., payment card company) conveying suggestions or recommendations to another entity (e.g., merchant) based on the indices. At step 602, a payment card company (part of the payment card company network 150 in FIG. 1) retrieves, from one or more databases, information including purchasing and payment information attributable to one or more payment card holders. The information at 602 includes payment card transaction information, payment card holder information (e.g., payment card holder account identifier (likely anonymized), payment card holder geography (potentially modeled), payment card holder type (consumer/business), payment card holder demographics, and the like), and purchasing and payment activities attributable to payment card holders. The payment card company retrieves, from one or more databases, at 604, merchant information. The merchant information at 604 includes categories of merchants, merchant name, merchant geography, merchant line of business, and the like. The merchant information 604 also includes, for example, a merchant identifier, geolocation of merchant, and the like. The payment card company optionally retrieves, from one or more databases, other information including demographic, firmographic and/or geographic information (not shown in FIG. 6).

In step 606, based on the first set of information and the second set of information and optionally third set of information, the payment card company creates one or more benchmarks for a rate of return of goods by a plurality of payment card holders to a plurality of merchants. The payment card company, at step 608, identifies a rate of return of goods by a plurality of payment card holders to a selected merchant based on the first set of information, the second set of information and optionally the third set of information.

In step 610, based on the first set of information, the second set of information and optionally third set of information, one or more indices are generated. The payment card company generates one or more indices based on the one or more benchmarks for rate of return of goods by the plurality of payment card holders to the plurality of merchants at 606 and the rate of return of goods by the plurality of payment card holders to the selected merchant at 608. The payment card company identifies activities and characteristics attributable to payment card holders based on the indices including, for example, frequency and timing of return of goods to a merchant, frequency and timing of shopping at a merchant after the return of goods to the merchant; frequency and timing of purchasing goods from a merchant after the return of goods to the merchant; and the like. Activities and characteristics attributable to the payment card holders are identified based on the one or more indices. The payment card company assesses, at 612, the behavior of the plurality of payment card holders with regard to their return of goods to a merchant based at least in part on the indices at 610.

The payment card company conveys suggestions or recommendations to a merchant, at 614, to enable the merchant to assess its return of goods policy and, if needed, modify its return of goods policy. For example, a merchant may want to make its return of goods policy more strict or less strict in an attempt to improve one or more of the generated indices. In an embodiment, the payment card company conveys to the merchant, at 614, a return of goods behavioral propensity score based on the indices. The score is indicative of a propensity of the plurality of payment card holders to exhibit a certain behavior with regard to their return of goods to a merchant based at least in part on the indices at 610.

In an embodiment, the merchant provides feedback to the payment card company to enable the payment card company to monitor and track impact of suggestions and recommendations. This “closed loop” system allows the merchant to track returns of goods, measure efficiency of the suggestions and recommendations, and make any improvements.

One or more algorithms can be employed to determine formulaic descriptions of the assembly of the payment card holder information including purchasing and payment transactions, merchant information, and optionally demographic, firmographic and/or geographic information, using any of a variety of known mathematical techniques. These formulas in turn can be used to derive or generate one or more benchmarks and indices using any of a variety of available trend analysis algorithms.

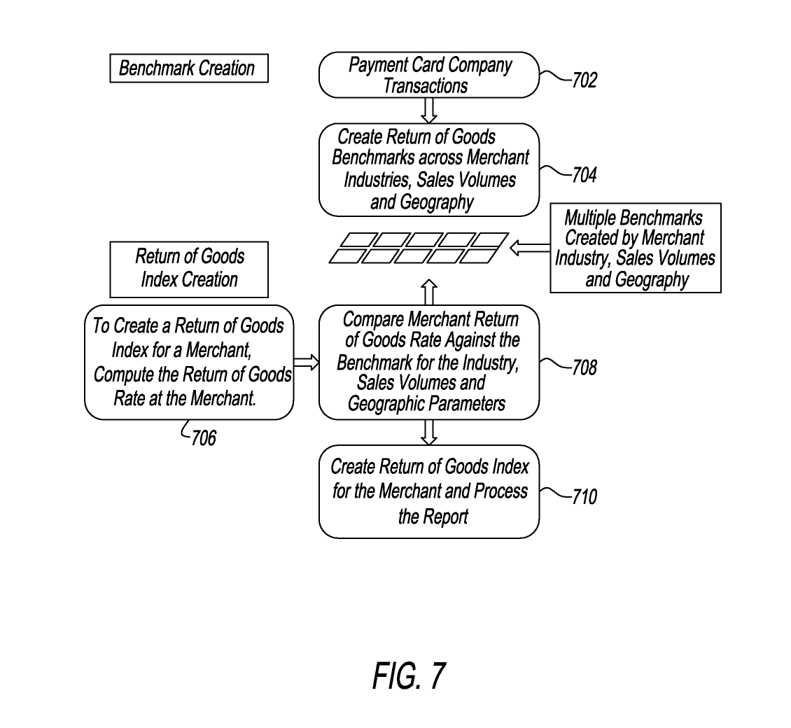

FIG. 7 a flow chart illustrating a method for creating benchmarks across merchant industries, sales volumes and geographies, identifying return of goods to a selected merchant, and creating indices based on the benchmarks and the return of good to the selected merchant, in accordance with exemplary embodiments of the present disclosure. At 702, a first set of information comprising payment card transaction information of a plurality of payment card holders is retrieved from one or more databases. A second set of information comprising merchant information of a plurality of merchants is also retrieved from one or more databases (not shown in FIG. 7). One or more benchmarks for a rate of return of goods by a plurality of payment card holders to a plurality of merchants are created at 704, based on the first set of information and the second set of information.

A rate of return of goods by a plurality of payment card holders to a selected merchant is identified at 706, based on the first set of information and the second set of information. A comparison is made at 708, based on the one or more benchmarks for rate of return of goods by the plurality of payment card holders to the plurality of merchants and the rate of return of goods by the plurality of payment card holders to the selected merchant. One or more indices based on the one or more benchmarks for rate of return of goods by the plurality of payment card holders to the plurality of merchants and the rate of return of goods by the plurality of payment card holders to the selected merchant are generated at 710. The rate of return of goods by the plurality of payment card holders to the selected merchant based on the one or more indices can then be assessed.

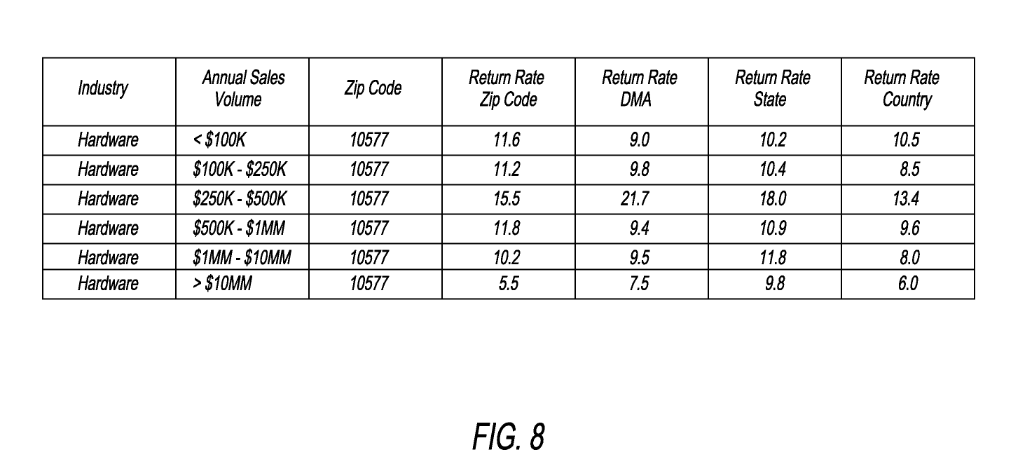

Illustrative benchmarks, indices and reports generated in accordance with this disclosure are exemplified in FIGS. 8-10. FIG. 8 is a table that illustrates benchmark data across hardware merchant industry, sales volumes and geographies, in accordance with exemplary embodiments of the present disclosure. The benchmarks are created for a rate of return of goods by a plurality of payment card holders to a plurality of merchants based on the first set of information and the second set of information. The benchmarks are created for a rate of return of goods by a plurality of payment card holders to a plurality of merchants across one or more merchant categories, merchant sales volumes, and merchant geographies.

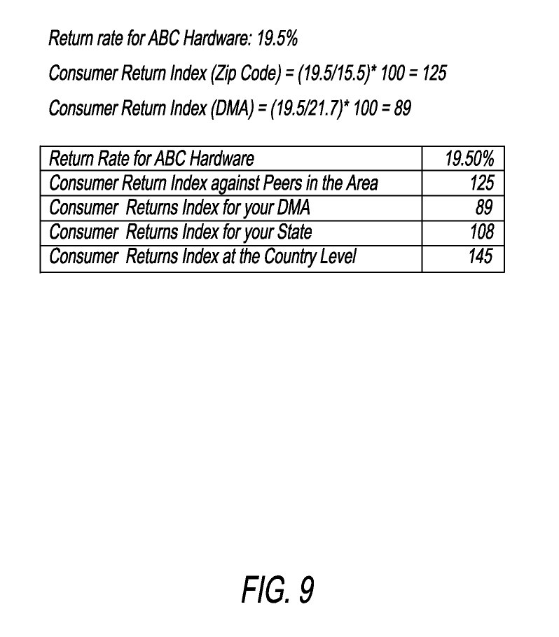

Referring to FIG. 9, an exemplary calculation of indices for a merchant, in accordance with exemplary embodiments of this disclosure is shown. Once the benchmark is created, the return of goods rate for the selected merchant is computed and one or more indices for the selected merchant are calculated as shown in FIG. 9. The one or more indices are a measure of the degree to which the rate of return of goods by a plurality of payment card holders to a selected merchant and the one or more benchmarks for the rate of return of goods by a plurality of payment card holders to a plurality of merchants are correlated across one or more merchant categories, merchant geographical locations, and/or merchant sales volumes. The one or more indices are also a measure of the degree to which the rate of return of goods by a plurality of payment card holders to a selected merchant and the one or more benchmarks for the rate of return of goods by a plurality of payment card holders to a plurality of merchants are correlated for a defined time period.

In an embodiment, an index can be a numerical value ranging from 0 to 500. An index of 0 indicates that the merchant does not have any returns of goods. An index between 1 and 99 indicates that the merchant is lower than their peers/competitors. An index of 100 indicates that the merchant is on par with other merchants. An index between 100 and 499 indicates that the merchant is higher than their peers/competitors. An index of 500 indicates that the merchant's return of goods is really high and immediate action is required.

In an embodiment, the one or more indices based on the one or more benchmarks for rate of return of goods by the plurality of payment card holders to the plurality of merchants and the rate of return of goods by the plurality of payment card holders to the selected merchant are algorithmically generated.

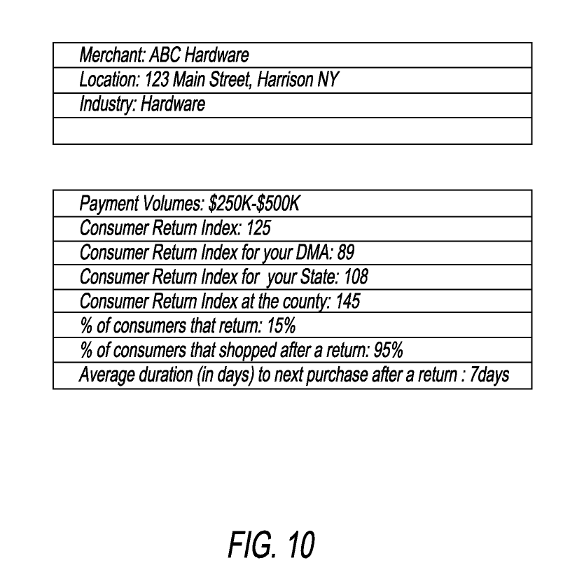

Referring to FIG. 10, an exemplary merchant report is illustrated, which report includes merchant information, indices and other calculated information, in accordance with exemplary embodiments of this disclosure.

The indices based on the first set of information, the second set of information and optionally the third set of information can be constructed by statistical analysis, for example, clustering, regression, correlation, segmentation, and raking. As also described herein, the indices can be algorithmically constructed based on the first set of information, the second set of information and optionally the third set of information.

In accordance with this disclosure, indexing can be used to determine frequency and timing of consumer return of goods; percent of consumers that return goods to the merchant; percent of consumers that shopped at the merchant after the return of goods to the merchant; percent of consumers that purchased goods at the merchant after the return of goods to the merchant; average duration (in days, for example) of consumers next purchase of goods at the merchant after the return of goods to the merchant; and monthly/quarterly time series reports of consumer return of goods index and other indices. Other uses are possible. The indexing is based on payment card holder transaction information, merchant categorization information and other information indicative of return of goods patterns of payment card holders.

An indexing score can be used for assessing return of goods behavior of the plurality of payment card holders. The indexing score can be trended over time. Proper merchant categorization is important for obtaining indexing results that are truly reflective of the particular merchant and industry, in particular, for determining how return of goods behavior is trending for one merchant in comparison to another merchant in the same industry category.

The indexing can be updated or refreshed at a specified time (e.g., on a regular basis or upon request of a party). Updating the indexing can include updating the payment card transaction data, merchant data, and optionally demographic data and/or updated geographic data. Indexing can also be updated by changing the attributes that define each merchant, and generating a different merchant categorization. The process for updating indexing can depend on the circumstances regarding the need for the information itself.

One or more algorithms can be used to determine formulaic descriptions of the assembly of the payment card transaction information, merchant categorization information, and optionally demographic and/or geographic information, using any of a variety of known mathematical techniques. These formulas in turn can be used to derive or generate indexing using any of a variety of available analysis algorithms.

In accordance with this disclosure, one or more predictive behavioral models are generated based at least in part on the first set of information and the second set of information. Predictive behavioral models can be selected based on the information obtained and stored in the one or more databases. The selection of information for representation in the predictive behavioral models can be different in every instance. In one embodiment, all information stored in each database can be used for selecting predictive behavioral models. In an alternative embodiment, only a portion of the information is used. The generation and selection of predictive behavioral models can be based on specific criteria.

Predictive behavioral models are generated from the information obtained from each database. The information is analyzed, extracted and correlated by, for example, a financial transaction processing company (e.g., a payment card company), and can include financial account information, merchant information, performing statistical analysis on financial account information and merchant information, finding correlations between account information, merchant information and payment card holder behaviors, predicting future payment card holder behaviors based on account information and merchant information, and the like.

Activities and characteristics attributable to the payment card holders based on the one or more predictive behavioral models are identified. The payment card holders have a propensity to carry out certain activities and to exhibit certain characteristics, based on the one or more predictive behavioral models. The activities and characteristics attributable to the payment card holders and based on the one or more predictive behavioral models are conveyed by the financial transaction processing entity to the entity (e.g., merchant) to take appropriate action, for example, modifying its return of goods policy in an attempt to better its index score. For example, a merchant may want to make its return of goods policy more strict or less strict in an attempt to improve one or more of the generated indices. The conveyance can be performed by any suitable method as will be apparent to persons having skill in the relevant art.

Predictive behavioral models can be defined based on geographical or demographical information, including but not limited to, age, gender, income, marital status, postal code, income, return of goods propensity, and familial status. In some embodiments, predictive behavioral models can be defined by a plurality of geographical and/or demographical categories. For example, a predictive behavioral model can be defined for any payment card holder who engages in purchasing and spending (including return of goods) activity.

Predictive behavioral models can also be based on behavioral variables. For example, the financial transaction processing entity database can store information relating to financial transactions. The information can be used to determine an individual's likeliness to return goods to a merchant at a particular date and time. An individual's likeliness to return can be represented generally, or with respect to a particular industry, retailer, brand, or any other criteria that can be suitable as will be apparent to persons having skill in the relevant art. An individual's behavior can also be based on additional factors, including but not limited to, time, location, and season. The factors and behaviors identified can vary widely and can be based on the application of the information.

Behavioral variables can also be applied to generated predictive behavioral models based on the attributes of the entities. For example, a predictive behavioral model of specific geographical and demographical attributes can be analyzed for return of goods behaviors. Results of the analysis can be assigned to the predictive behavioral models.

In an embodiment, the information retrieved from each of the databases can be analyzed to determine behavioral information of the payment card holders. Also, information related to an intention of the payment card holders can be extracted from the behavioral information. The predictive behavioral models can be based upon the behavioral information of the payment card holders and the intent of the payment card holders. The predictive behavioral models can be capable of predicting behavior and intent in the payment card holders.

In analyzing information to determine behavioral information, intent and other payment card holder attributes are considered. Developing intent of payment card holders involves models that predict specific return of goods behavior at certain times in the future and desirable return of goods behaviors.

Predictive behavioral models can equate to purchase behaviors. There can be different degrees of predictive behavioral models with the ultimate behavior being a return of goods.

The one or more predictive behavioral models are capable of predicting behavior and intent in the one or more payment card holders. The one or more payment card holders are people and/or businesses; the activities attributable to the one or more payment card holders are purchasing and spending (including return of goods) transactions; and the characteristics attributable to the one or more payment card holders are demographics and/or geographical characteristics.

A behavioral propensity score can be used for conveying to the entity the activities and characteristics attributable to the one or more payment card holders based on the one or more predictive behavioral models. The behavioral propensity score is indicative of a propensity to exhibit a certain behavior.

Potential payment card holders can represent a wide variety of categories and attributes. In one embodiment, potential payment card holder categories can be created based on spending propensity in a particular industry. Industries can include, as will be apparent to persons having skill in the relevant art, restaurants (e.g., fine dining, family restaurants, fast food), apparel (e.g., women's apparel, men's apparel, family apparel), entertainment (e.g., movies, professional sports, concerts, amusement parks), accommodations (e.g., luxury hotels, motels, casinos), retail (e.g., department stores, discount stores, hardware stores, sporting goods stores), automotive (e.g., new car sales, used car sales, automotive stores, repair shops), travel (e.g., domestic, international, cruises), and the like. Each industry can include a plurality of potential payment card holders (e.g., based on location, income groups, and the like).

A financial transaction processing company can analyze the generated predictive behavioral models (e.g., by analyzing the stored data for each entity comprising the predictive behavioral model) for behavioral information (e.g., return of goods behaviors and propensities). In some embodiments, the behavioral information can be represented by a behavioral propensity score. Behavioral information can be assigned to each corresponding predictive behavioral model.

Predictive behavioral models or behavioral information can be updated or refreshed at a specified time (e.g., on a regular basis or upon request of a party). Updating predictive behavioral models can include updating the entities included in each predictive behavioral model with updated demographic data and/or updated financial data. Predictive behavioral models can also be updated by changing the attributes that define each predictive behavioral model, and generating a different set of behaviors. The process for updating behavioral information can depend on the circumstances regarding the need for the information itself.

Although the above methods and processes are disclosed primarily with reference to financial data and return of goods behaviors, it will be apparent to persons having skill in the relevant art that the predictive behavioral models can be beneficial in a variety of other applications. Predictive behavioral models can be useful in the evaluation of consumer data that may need to be protected.

The payment card company analyzes the first set of information and second set of information to determine behavioral information of the payment card holders. The payment card company extracts information related to intent of the payment card holders from the behavioral information.

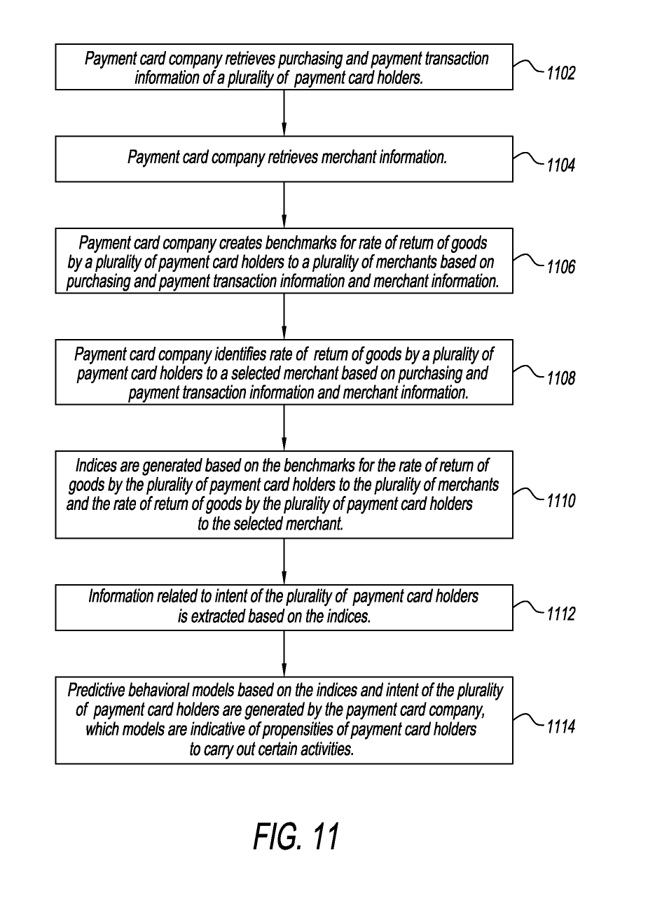

A method for generating one or more predictive behavioral models is an embodiment of this disclosure. Referring to FIG. 11, the method involves a payment card company (part of the payment card company network 150 in FIG. 1) retrieving, from one or more databases, information including activities and characteristics (e.g., purchasing and payment transaction information) attributable to one or more payment card holders. The information at 1102 includes payment card transaction information, payment card holder information (e.g., payment card holder account identifier (likely anonymized), payment card holder geography (potentially modeled), payment card holder type (consumer/business), payment card holder demographics, and the like), and purchasing and payment activities attributable to payment card holders. The payment card company retrieves, from one or more databases, at 1104 merchant information. The merchant information at 1104 includes categories of merchants, merchant name, merchant geography, merchant line of business, and the like. The merchant information 1104 also includes, for example, a merchant identifier, geolocation of merchant, and the like. The payment card company optionally retrieves, from one or more databases, other information including demographic, firmographic and/or geographic information (not shown in FIG. 11).

In step 1106, based on the first set of information and the second set of information and optionally third set of information, the payment card company creates one or more benchmarks for a rate of return of goods by a plurality of payment card holders to a plurality of merchants. The payment card company, at step 1108, identifies a rate of return of goods by a plurality of payment card holders to a selected merchant based on the first set of information, the second set of information and optionally the third set of information.

In step 1110, based on the first set of information, the second set of information and optionally third set of information, one or more indices are generated. The payment card company generates one or more indices based on the one or more benchmarks for rate of return of goods by the plurality of payment card holders to the plurality of merchants at 1106 and the rate of return of goods by the plurality of payment card holders to the selected merchant at 1108. The payment card company identifies activities and characteristics attributable to payment card holders based on the indices including, for example, frequency and timing of return of goods to a merchant, frequency and timing of shopping at a merchant after the return of goods to the merchant; frequency and timing of purchasing goods from a merchant after the return of goods to the merchant; and the like. Activities and characteristics attributable to the payment card holders are identified based on the one or more indices.

Information related to an intent of the one or more payment card holders is extracted from the indices at 1112. One or more predictive behavioral models are generated at 1114 based on the behavioral information and intent of the one or more payment card holders. The one or more payment card holders have a propensity to carry out certain activities at certain times based on the one or more predictive behavioral models.

The payment card company identifies activities and characteristics attributable to payment card holders based on the predictive behavioral models. The activities and characteristics attributable to the payment card holders based on the one or more predictive behavioral models are conveyed to merchant, to enable the merchant to assess its return of goods policy and, if needed, modify its return of goods policy. For example, a merchant may want to make its return of goods policy more strict or less strict in an attempt to improve one or more of the generated indices. In an embodiment, the payment card company conveys to the entity a behavioral propensity score based on the predictive behavioral models. The score is indicative of a propensity of a payment card holder to exhibit a certain behavior.

Illustrative payment card holder behaviors include, for example, a propensity of the payment card holder to: (i) return goods to a merchant including frequency and time of return of goods to a merchant; (ii) shop at a merchant after the return of goods to the merchant including frequency and time of shopping at the merchant; and (iii) purchase at a merchant after the return of goods to the merchant including frequency and time of purchasing at the merchant.

It will be understood that the present disclosure can be embodied in a computer readable non-transitory storage medium storing instructions of a computer program that when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

The techniques described herein are exemplary, and should not be construed as implying any particular limitation on the present disclosure. It should be understood that various alternatives, combinations and modifications can be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving from one or more databases a first set of information comprising payment card transaction information of a plurality of payment card holders;
retrieving from one or more databases a second set of information comprising merchant information of a plurality of merchants;
creating one or more benchmarks for a rate of return of goods by a plurality of payment card holders to a plurality of merchants based on the first set of information and the second set of information;
identifying a second rate of return of goods by a plurality of payment card holders to a selected merchant based on the first set of information and the second set of information;
generating one or more indices based on the one or more benchmarks for rate of return of goods by the plurality of payment card holders to the plurality of merchants and the second rate of return of goods by the plurality of payment card holders to the selected merchant; and
assessing the second rate of return of goods by the plurality of payment card holders to the selected merchant based on the one or more indices.

2. The method of claim 1, further comprising:
creating one or more benchmarks for the rate of return of goods by a plurality of payment card holders to a plurality of merchants across one or more merchant categories, merchant sales volumes, and merchant geographies.

3. The method of claim 1, wherein the merchant information is clustered or aggregated across one or more merchant categories, merchant geographical locations, and/or merchant sales volumes.

4. The method of claim 1, wherein the one or more indices are a measure of the degree to which the second rate of return of goods by a plurality of payment card holders to a selected merchant and the one or more benchmarks for the rate of return of goods by a plurality of payment card holders to a plurality of merchants are correlated across one or more merchant categories, merchant geographical locations, and/or merchant sales volumes.

5. The method of claim 3, wherein the merchant categories are constructed by industry sector.

6. The method of claim 1, further comprising:
retrieving from the one or more databases a third set of information comprising other information, wherein the other information comprises geographic data, firmographic data, and demographic data.

7. The method of claim 1, further comprising targeting information including at least one or more suggestions or recommendations for the selected merchant, based on the one or more indices.

8. The method of claim 1, further comprising creating one or more datasets to store information relating to the payment card transaction information; one or more categories of merchants based on merchant industry or line of business, merchant location and/or merchant sales volumes; one or more benchmarks for a rate of return of goods by a plurality of payment card holders to a plurality of merchants; a rate of return of goods by a plurality of payment card holders to a selected merchant; and one or more indices based on the one or more benchmarks for rate of return of goods by the plurality of payment card holders to the plurality of merchants and the rate of return of goods by the plurality of payment card holders to the selected merchant.

9. The method of claim 1, further comprising developing logic for creating one or more benchmarks for a rate of return of goods by a plurality of payment card holders to a plurality of merchants based on the first set of information and the second set of information; identifying a rate of return of goods by a plurality of payment card holders to a selected merchant based on the first set of information and the second set of information; generating one or more indices based on the one or more benchmarks for rate of return of goods by the plurality of payment card holders to the plurality of merchants and the rate of return of goods by the plurality of payment card holders to the selected merchant; and assessing the rate of return of goods by the plurality of payment card holders to the selected merchant based on the one or more indices.

10. The method of claim 1, further comprising algorithmically constructing the one or more indices based on the one or more benchmarks for rate of return of goods by the plurality of payment card holders to the plurality of merchants and the second rate of return of goods by the plurality of payment card holders to the selected merchant.

11. A system comprising:
one or more databases configured to store a first set of information comprising payment card transaction information of a plurality of payment card holders;
one or more databases configured to store a second set of information comprising merchant information of a plurality of merchants;
a processor configured to:
create one or more benchmarks for a rate of return of goods by a plurality of payment card holders to a plurality of merchants based on the first set of information and the second set of information;
identify a second rate of return of goods by a plurality of payment card holders to a selected merchant based on the first set of information and the second set of information;
generate one or more indices based on the one or more benchmarks for the rate of return of goods by the plurality of payment card holders to the plurality of merchants and the second rate of return of goods by the plurality of payment card holders to the selected merchant; and
assess the rate of return of goods by the plurality of payment card holders to the selected merchant based on the one or more indices.

12. The system of claim 11, wherein the processor is configured to:
create one or more benchmarks for the rate of return of goods by a plurality of payment card holders to a plurality of merchants across one or more merchant categories, merchant sales volumes, and merchant geographies.

13. The system of claim 11, wherein the merchant information is clustered or aggregated across one or more merchant categories, merchant geographical locations, and/or merchant sales volumes.

14. The system of claim 11, wherein the one or more indices are a measure of the degree to which the second rate of return of goods by a plurality of payment card holders to a selected merchant and the one or more benchmarks for the rate of return of goods by a plurality of payment card holders to a plurality of merchants are correlated across one or more merchant categories, merchant geographical locations, and/or merchant sales volumes.

15. The system of claim 11, further comprising:
one or more databases configured to store a third set of information comprising other information, wherein the other information comprises geographic data, firmographic data, and demographic data.

16. The system of claim 11, wherein the processor is configured to target information including at least one or more suggestions or recommendations for a merchant, based on the one or more indices.

17. A method for generating one or more predictive behavioral models, the method comprising:
retrieving from one or more databases a first set of information comprising payment card transaction information of a plurality of payment card holders;
retrieving from one or more databases a second set of information comprising merchant information of a plurality of merchants;
creating one or more benchmarks for a rate of return of goods by a plurality of payment card holders to a plurality of merchants based on the first set of information and the second set of information;
identifying a second rate of return of goods by a plurality of payment card holders to a selected merchant based on the first set of information and the second set of information;
generating one or more indices based on the one or more benchmarks for the rate of return of goods by the plurality of payment card holders to the plurality of merchants and the second rate of return of goods by the plurality of payment card holders to the selected merchant; and
extracting information related to an intent of the plurality of payment card holders based on the one or more indices; and
generating one or more predictive behavioral models based on the one or more indices and the intent of the plurality of payment card holders, wherein the plurality of payment card holders have a propensity to carry out certain activities based on the one or more predictive behavioral models.

18. The method of claim 17, further comprising:
assessing the propensity of the plurality of payment card holders to (i) return goods to a merchant including frequency and time of return of goods to a merchant; (ii) shop at a merchant after the return of goods to the merchant including frequency and time of shopping at the merchant; and (iii) purchase at a merchant after the return of goods to the merchant including frequency and time of purchasing at the merchant, based on the one or more predictive behavioral models.

19. The method of claim 17, further comprising:
creating one or more benchmarks for the rate of return of goods by a plurality of payment card holders to a plurality of merchants across one or more merchant categories, merchant sales volumes, and merchant geographies.

20. The method of claim 17, wherein the merchant information is clustered across one or more merchant categories, merchant geographical locations, and/or merchant sales volumes.
